(19) United States
(12) Patent Application Publication
(10) Pub. No.: US 2009/0089068 A1
(43) Pub. Date: Apr. 2, 2009

(54) Method of Automatically Configuring Replacement Modules in Vehicles

(75) Inventors: Douglas J. McKibbon, Farmington Hills, MI (US); Robert J. Casper, Canton, MI (US); Amelia Majeske, Troy, MI (US); Andrea Munzenberger, Livonia, MI (US); Bhagyashri Chander, Farmington Hills, MI (US); Mark D'Errico, Farmington Hills, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 11/864,275

(22) Filed: Sep. 28, 2007

(51) Int. Cl. G06Q 99/00; G06F 17/30; G06F 17/40; G06F 19/00

(52) U.S. Cl. 705/1; 701/32

(57) ABSTRACT

Replacement modules are mapped to a telematics subscriber's account to allow a provider to properly manage a subscriber's services. Aspects of the invention allow vehicle dealer personnel to map replacement modules automatically through a provider website without contacting a live advisor. Subsequently, the provider automatically completes configuration of the replacement module via a wireless network.

### BACKGROUND OF THE INVENTION

One of the fastest growing areas of communications technology is related to automobile network solutions. Almost all new American cars will come equipped with some level of telematics service, and with the increasing number and variety of these services, demands on telematics service call centers have also grown.

With the growth of telematics services being offered and telematics units being sold, there is need to replace telematics unit modules and components to update telematics technology in addition to repair and maintenance. Replacement modules are mapped to a telematics subscriber's account to allow a provider to properly manage a subscriber's services. Authorized repair facilities have traditionally spoken with a live advisor or telematics service representative to map a replacement module to a subscriber account. Subsequently, the live advisor then completes the configuration of the replacement module across a wireless network.

### BRIEF SUMMARY OF THE INVENTION

If a module in a telematics unit is in need of replacement because of update, repair or maintenance, an authorized telematics unit repair facility or vehicle dealer may order and install a replacement module. Replacement modules are mapped to a telematics subscriber's account to allow a provider to properly manage a subscriber's services. Aspects of the invention allow vehicle dealer personnel to map replacement modules automatically through a provider website without contacting a live advisor. Subsequently, the provider automatically completes configuration of the replacement module. This generates time savings for the vehicle dealer and cost savings for the provider because no live advisor is needed to complete the configuration. In addition, the opportunities for introduction of human error are reduced

### BRIEF DESCRIPTION OF THE SEVERAL VIEWS OF THE DRAWINGS

FIG. 1 is a schematic view of an example communication system within which examples of the disclosed system may be implemented;

FIG. 2 is a general overview of system architecture in keeping with the disclosed principles;

FIG. 3 is a further architectural overview in keeping with the disclosed principles; and

FIG. 4 is a flow diagram that illustrates an exemplary method of automatically configuring replacement modules of a telematics unit.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

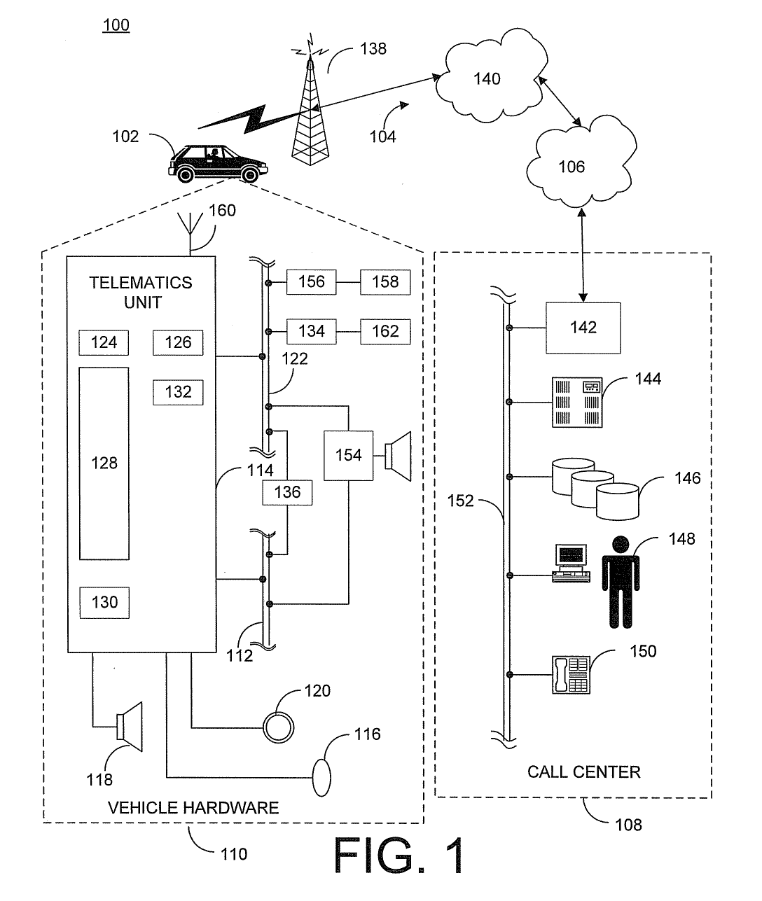

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle. Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

If any module in the telematics unit 114 is in need of replacement because of repair or maintenance, or to update in technology, an authorized telematics unit repair facility or vehicle dealer can order and install the replacement module. Replacement modules are mapped to a telematics subscriber's account to allow a provider to properly manage a subscriber's services. Authorized repair facilities have traditionally had to speak with a live advisor or telematics service representative to map a replacement module to a subscriber account. Subsequently, the live advisor finishes configuring the replacement module over a wireless network.

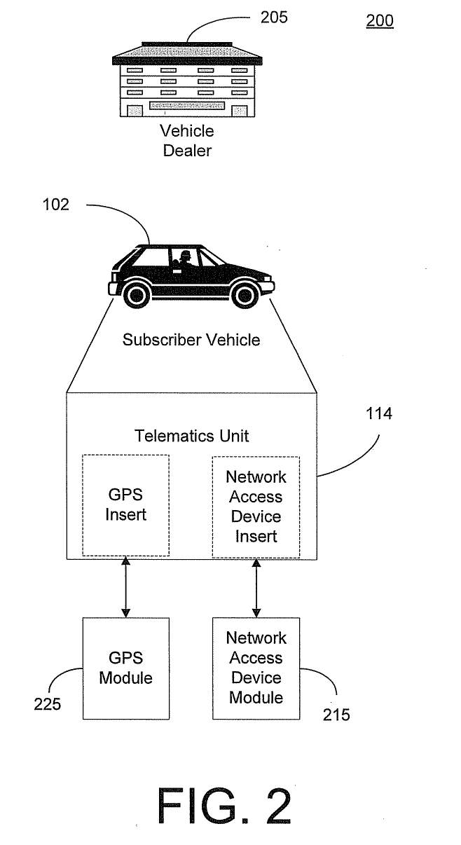

Certain aspects of the invention allow vehicle dealer personnel to map replacement modules automatically through a provider website without contacting a live advisor. Subsequently, the provider automatically completes configuration of the replacement module. FIG. 2 is a general architectural overview 200 of an embodiment of the invention. An authorized repair facility or vehicle dealer 205 replaces the GPS 225 and Network Access Device (NAD) modules 215 of a telematics unit 114 of a subscriber vehicle.

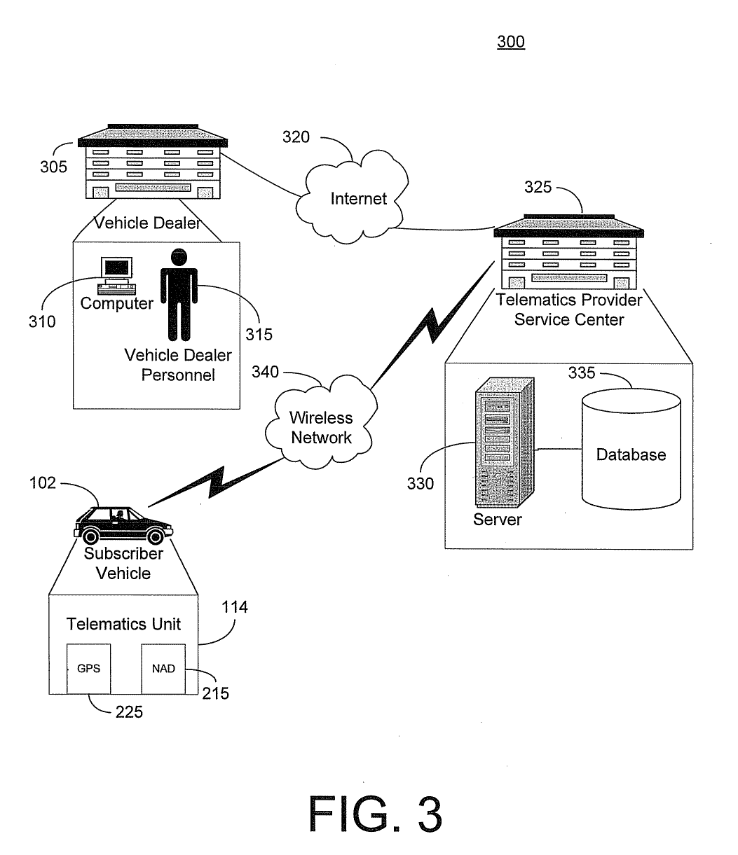

FIG. 3 is a further general architectural overview 300 showing additional and alternative aspects of the invention. A vehicle dealer 305 may access a telematics service provider website from a computer 310 over the Internet 320 (or other wide area network). Vehicle dealer personnel 315 then enter pertinent subscriber and telematics unit information into the provider website during replacement of a telematics unit module. A server 330 at a telematics service provider center stores this subscriber and telematics unit information in one or more databases 335. After the replacement modules are installed (215, 225) and the telematics unit in the subscriber's vehicle 102 contacts the provider 325, the provider through its server 330, completes configuration of the replacement modules (215, 225) across a wireless network 340.

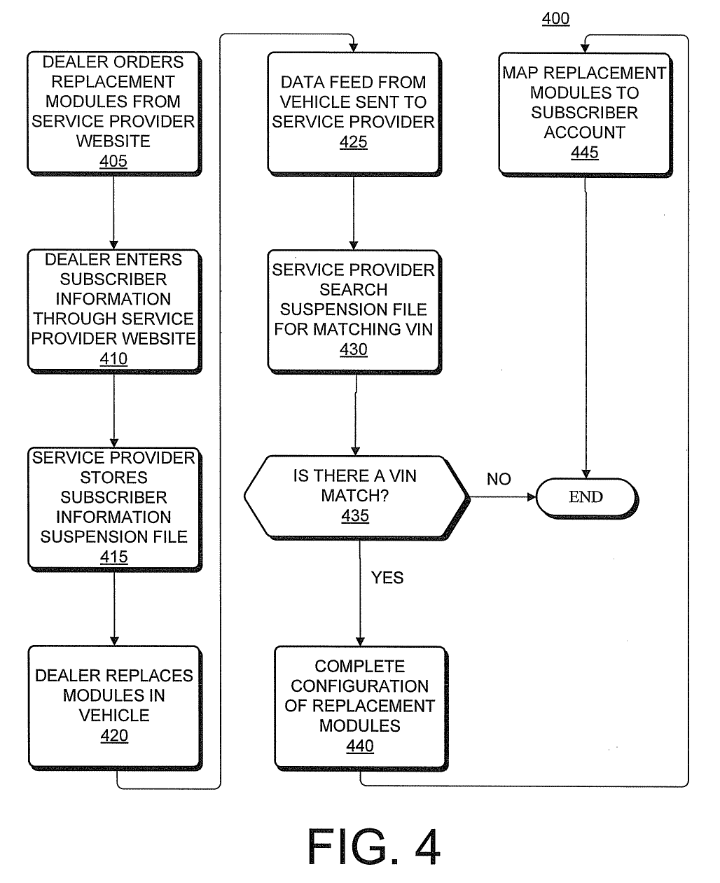

FIG. 4 is a flow diagram that illustrates an exemplary method of automatically configuring replacement modules of a telematics unit. At stage 405, an authorized repair facility or vehicle dealer orders replacement modules from a service provider website. Subsequently at stage 410, a dealer enters subscriber and telematics unit information through a provider website. This information may include, but is not limited to, subscriber name, address, replacement module, Vehicle Identification Number (VIN), and other pertinent information. At a next stage 415, a service provider stores the information from the vehicle dealer into a suspension file in a database. The dealer replaces one or more modules in the telematics unit at stage 425. At a next stage 425, a data feed from the telematics unit equipped vehicle 102 is sent to and received by the provider server 330. In one aspect of the disclosed example, this his data feed may include the VIN of the vehicle 102. At stage 430, the service provider server 330 searches the suspension files in the database to match the VIN. The provider server determines whether there is a match between the VIN from the data feed and a VIN in any one of the suspension files at stage 435. If there is no match between the VIN from the data feed and the VINs of the suspension files, then the process ends. Otherwise, at stage 440, the server 330 completes the configuration of the replacement modules across the wireless network. Given the teachings herein, those of skill in the art will be familiar with the data exchange needed to complete the configurations. At stage 445, the server maps the replacement modules to the subscriber's account to properly manage the subscriber's services, after which the process ends.

It will be appreciated that an improved system of replacement module configuration has been disclosed herein. All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for automatically configuring a replacement module in a telematics unit, the method comprising:
(a) receiving repair identity information from repair facility personnel at a telematics service provider server, a replacement module having been installed into the telematics unit by the repair facility personnel, and storing at least a portion of the repair identity information in a suspension file in one or more databases;
(b) receiving a data feed at a server from the telematics unit, the data feed including the vehicle identification number;
(c) comparing the vehicle identification number from the data feed to a plurality of vehicle identification numbers in one or more suspension files in the one or more databases;
(d) detecting a match between the vehicle identification number from the data feed and a vehicle identification number in a suspension file in the one or more databases; and
(e) completing configuration of the replacement module across a wireless network by the server.

2. The method according to claim 1, wherein the repair identity information comprises subscriber, telematics unit, and vehicle information, including a vehicle identification number.

3. The method according to claim 2, wherein storing at least a portion of the repair identity information in a suspension file in one or more databases comprises storing the vehicle information in the one or more databases.

4. The method according to claim 1, wherein receiving subscriber, telematics unit, and vehicle information further comprises receiving at a telematics service provider server through a user interface an order of the replacement module from the repair facility personnel.

5. The method according to claim 1, further comprising mapping the replacement module to a subscriber account.

6. The method according to claim 1, wherein the wireless network is selected from the group consisting of wireless wide area networks, wireless metropolitan area networks, wireless local area networks, CDMA2000, Evolution Data Optimized (EVDO), High Speed Downlink Packet Access (HSDPA), GSM, WiFi, and WiMAX networks.

7. The method according to claim 1, wherein the replacement module comprises a GPS module.

8. The method according to claim 1, wherein the replacement module comprises a NAD module.

9. A method for automatically configuring a replacement module in a telematics unit comprising:
sending subscriber information to a telematics service provider via a first network;
installing the replacement module in the telematics unit; and
activating the telematics unit, whereby the telematics service provider completes configuration of the replacement module via a second network comprising a wireless network.

10. The method according to claim 9, wherein the replacement module comprises at least one of a GPS module and a NAD module.

11. The method according to claim 9, wherein the subscriber information comprises a vehicle identification number, relative to the vehicle

12. The method according to claim 9, further comprising requesting the replacement module via a user interface of the telematics service provider website.

13. A computer-readable medium having thereon computer-executable instructions for performing a method of automatically configuring a replacement module in a telematics unit, the computer-executable instructions comprising:
(a) instructions for receiving repair identity information from repair facility personnel at a telematics service provider server, a replacement module having been installed into the telematics unit by the repair facility personnel, and storing at least a portion of the repair identity information in a suspension file in one or more databases;
(b) instructions for receiving a data feed at a server from the telematics unit, the data feed including the vehicle identification number;
(c) instructions for comparing the vehicle identification number from the data feed to a plurality of vehicle identification numbers in one or more suspension files in the one or more databases;
(d) instructions for detecting a match between the vehicle identification number from the data feed and a vehicle identification number in a suspension file in the one or more databases; and
(e) instructions for completing configuration of the replacement module across a wireless network by the server.

14. The computer-readable medium according to claim 13, wherein the repair identity information comprises subscriber, telematics unit, and vehicle information, including a vehicle identification number.

15. The computer-readable medium according to claim 14, wherein the instructions for storing at least a portion of the repair identity information in a suspension file in one or more databases comprise instructions for storing the vehicle information in the one or more databases.

16. The computer-readable medium according to claim 13, wherein the instructions for receiving subscriber, telematics unit, and vehicle information further comprise instructions for receiving at a telematics service provider server through a user interface an order of the replacement module from the repair facility personnel.

17. The computer-readable medium according to claim 13, further comprising instructions for mapping the replacement module to a subscriber account.

18. The computer-readable medium according to claim 13, wherein the wireless network is selected from the group consisting of wireless wide area networks, wireless metropolitan area networks, wireless local area networks, CDMA2000, Evolution Data Optimized (EVDO), High Speed Downlink Packet Access (HSDPA), GSM, WiFi, and WiMAX networks.

19. The computer-readable medium according to claim 13, wherein the replacement module comprises a GPS module.

20. The computer-readable medium according to claim 13, wherein the replacement module comprises a NAD module.
